(19) United States
(12) Patent Application Publication
(10) Pub. No.: US 2025/0136802 A1
(43) Pub. Date: May 1, 2025

(54) HIGH CLARITY AND DUCTILE MOLDING COMPOSITION COMPRISING A SMMA COPOLYMER, A SBC-BLOCK COPOLYMER AND AT LEAST ONE LIGHT STABILIZER

(71) Applicant: INEOS STYROLUTION GROUP GMBH, Frankfurt am Main (DE)

(72) Inventors: Jarrett R. ROWLETT, Oswego, IL (US); Thomas W. COCHRAN, Wilmington, IL (US)

(21) Appl. No.: 18/835,787

(22) PCT Filed: Feb. 13, 2023
(86) PCT No.: PCT/EP2023/053525

§ 371 Date: Aug. 5, 2024

(30) Foreign Application Priority Data
Feb. 14, 2022 (EP) 22156632.6

(51) Int. Cl. C08L 25/14

(52) U.S. Cl. CPC C08L 25/14; C08L 2201/08

(57) ABSTRACT

High clarity and ductile molding composition comprising: (a) 71 to 98.99 wt.-% of at least one random copolymer (a) made from 44 to 64 wt.-% of at least one vinylaromatic monomer (a11), and 36 to 56 wt.-%, methyl methacrylate (a12); (b) 1 to 28.99 wt.-% of at least one vinylaromatic-diene block copolymer (b) which comprises at least one hard blocks S made from vinylaromatic monomers and at least one soft block B made from dienes, and/or at least one soft block B/S made from dienes and vinylaromatic monomers; where the proportion of diene-based on entire block copolymer (b) is 47 to 67 wt.-%; (c) 0.01 to 1.0 wt.-% of at least one light stabilizer (c); (d) 0 to 1.0 wt.-% of at least one antioxidant (d); and (e) 0 to 5 wt.-% of one or more additive(s) and/or processing aid(s) (e), different from the light stabilizer(s) (c) and antioxidant(s) (d); have good light stability and processability.

The invention relates to a molding composition comprising a styrene-methyl methacrylate (SMMA) copolymer, a styrene-butadiene (SBC) block copolymer and at least one light stabilizer. These molding compositions and products therefrom have high clarity, light stability and processability. The invention also relates to a process for the preparation method and to thermoplastic molding compositions and shaped articles produced therefrom and to their use.

Styrene-butadiene block copolymers are known for years to provide effective modifiers to gain impact strength in blends with styrene-methyl methacrylate copolymers while still maintaining a good transparency and/or low haze.

U.S. Pat. Nos. 5,290,862 and 6,734,247 describe blends of SMMA copolymers (MMA content: 25 to 35 wt.-%) and SBC with the SBC having a tapered, linear or radial, di-block (vinyl aromatic monomer-conjugated diene) or tri-block (vinyl aromatic monomer-conjugated diene-vinyl aromatic monomer) molecular architecture.

WO 2018/091513 discloses a polymer composition comprising 48 to 67 wt.-% of a SMMA copolymer (MMA content: 10 to 35 wt.-%) and 33 to 52 wt.-% of a star-shaped vinyl-aromatic diene block copolymer (diene content: 15 to 50 wt.-%) comprising at least two terminal vinyl-aromatic polymer blocks S1 and S2 and at least one random vinyl-aromatic/diene copolymer block (B/S) and optionally additives such as UV stabilizers. Said compositions show an improved toughness and clarity.

However, the light stability and processability of said prior art compositions are still in need of improvement. Certain applications require this specific combination of properties. It is an object of the invention to provide a molding composition comprising SMMA copolymers and SBC block copolymers with a good balance of stiffness and toughness, with a high light stability while maintaining a high transmittance and clarity. It is a further object of the invention to provide a SMMA/SBC-molding composition having an improved processability (i.e. in an extrusion process).

According to the invention, this object is achieved by providing a molding composition according to the claims.

One aspect of the invention is a molding composition comprising (or consisting of) components (a), (b), (c), (d) and (e):
(a) 71 to 98.99 wt.-% of at least one random copolymer (a) made from 44 to 64 wt.-% of at least one vinylaromatic monomer (a11), in particular styrene, and 36 to 56 wt.-%, methyl methacrylate (a12);
(b) 1 to 28.99 wt.-% of at least one vinylaromatic-diene block copolymer (b) which comprises at least one hard block S made from vinylaromatic monomers, in particular styrene, and at least one soft block B made from dienes, in particular butadiene, and/or at least one soft block B/S made from dienes and vinylaromatic monomers, in particular butadiene and styrene, where the proportion of the diene—based on the entire block copolymer (b)—is from 47 to 67 wt.-%;
(c) 0.01 to 1.0 wt.-% of at least one light stabilizer (c);
(d) 0 to 1.0 wt.-% of at least one antioxidant (d); and
(e) 0 to 5 wt.-% of one or more additive(s) and/or processing aid(s) (e), different from the light stabilizer(s) (c) and antioxidant(s) (d);
wherein the total amount of components (a), (b), (c), (d) and (e) is 100 wt.-%.

In this document, wt.-% means percent by weight.

In this document, the term “diene” or “diene monomers” refers to olefinic monomers having least two C—C double bonds, wherein at least one C—C double bond is a terminal C—C double bond and the second double bond is preferably an conjugated double bond, i.e. a monomer of the general formula (I):

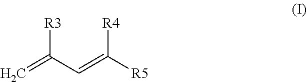

wherein
R3 is selected from hydrogen and saturated hydrocarbon groups comprising 1 to 10 carbon atoms, preferably selected from hydrogen and saturated hydrocarbon groups comprising 1 or 2 carbon atoms;
R4 is selected from hydrogen and saturated hydrocarbon groups comprising 1 to 10 carbon atoms, preferably selected from hydrogen and saturated hydrocarbon groups comprising 1 or 2 carbon atoms; and
R5 is selected from hydrogen and saturated hydrocarbon groups comprising 1 to 10 carbon atoms, preferably selected from hydrogen and saturated hydrocarbon groups comprising 1 to 3 carbon atoms.

A random copolymer (a) means a copolymer having a statistical distribution of the polymerized units of the vinylaromatic monomer and methyl methacrylate.

In one embodiment of the invention, the molding composition according to the invention comprises (or consists of) components (a), (b), (c), (d) and (e) in the following amounts:
75 to 98.48 wt.-%, more preferably 78 to 97.95 wt.-%, for example 78 to 97.85 wt.-%, of component (a)
1.5 to 24.98 wt.-%, more preferably 2 to 21.95 wt.-%, for example 2 to 21.85 wt.-%, of component (b),
0.02 to 0.8 wt.-%, more preferably 0.05 to 0.5 wt.-%, of component (c),
0 to 1 wt.-%, more preferably 0.1 to 0.7 wt.-%, of component (d),
0 to 5 wt.-%, more preferably 0 to 3 wt.-%, of component (e),
wherein the total amount of components (a), (b), (c), (d) and (e) is 100 wt.-%.

In one embodiment of the invention, the molding composition according to the invention comprises (or consists of) components (a), (b), (c), (d) and (e) in the following amounts:
72 to 96.98 wt.-%, more preferably 73 to 95.85 wt.-%, for example 74 to 94.85 wt.-%, of component (a)
3 to 27.98 wt.-%, more preferably 4 to 26.85 wt.-%, for example 5 to 25.85 wt.-%, of component (b),
0.02 to 0.8 wt.-%, more preferably 0.05 to 0.5 wt.-%, of component (c),
0 to 1 wt.-%, more preferably 0.1 to 0.7 wt.-%, of component (d),
0 to 5 wt.-%, more preferably 0 to 3 wt.-%, of component (e),
wherein the total amount of components (a), (b), (c), (d) and (e) is 100 wt.-%.

In one embodiment of the invention, the molding composition comprises (or consists of) components (a), (b), (c), (d) and (e) in the following amounts:
90 to 97.95 wt.-%, preferably 95 to 96.7 wt.-%, of component (a)
2 to 9.95 wt.-%, preferably 3 to 4.7 wt.-%, of component (b),
0.05 to 0.4 wt.-%, preferably 0.1 to 0.4 wt.-%, of component (c),
0 to 1 wt.-%, preferably 0.1 to 0.7 wt.-%, of component (d),
0 to 3 wt.-%, preferably 0.1 to 3.0 wt.-%, of component (e),
wherein the total amount of components (a), (b), (c), (d) and (e) is 100 wt.-%.

More preferably, the molding composition comprises (or consists of) components (a), (b), (c), (d) and (e) in the following amounts:
95 to 96.7 wt.-% of component (a)
3 to 4.7 wt.-%, of component (b),
0.1 to 0.4 wt.-%, of component (c),
0 to 1 wt.-%, preferably 0.1 to 0.7 wt.-%, of component (d),
0 to 3 wt.-%, preferably 0.1 to 3.0 wt.-%, of component (e),
wherein the total amount of components (a), (b), (c), (d) and (e) is 100 wt.-%.

In an alternative embodiment of the invention, the molding composition comprises (or consists of) components (a), (b), (c), (d) and (e) in the following amounts:
73 to 89.95 wt.-%, preferably 75 to 84.7 wt.-%, of component (a)
10 to 26.95 wt.-%, preferably 15 to 24.7 wt.-%, of component (b),
0.05 to 0.4 wt.-%, preferably 0.1 to 0.4 wt.-%, of component (c),
0 to 1 wt.-%, preferably 0.1 to 0.7 wt.-%, of component (d),
0 to 3 wt.-%, preferably 0.1 to 3 wt.-%, of component (e),
wherein the total amount of components (a), (b), (c), (d) and (e) is 100 wt.-%.

More preferably, the molding composition comprises (or consists of) components (a), (b), (c), (d) and (e) in the following amounts:
75 to 84.7 wt.-%, of component (a)
15 to 24.7 wt.-%, of component (b),
0.1 to 0.4 wt.-%, of component (c),
0 to 1 wt.-%, preferably 0.1 to 0.7 wt.-%, of component (d),
0 to 3 wt.-%, preferably 0.1 to 3 wt.-%, of component (e),
wherein the total amount of components (a), (b), (c), (d) and (e) is 100 wt.-%.

If components (d) and/or (e) are present, the minimum amount is usually 0.1 wt.-% for component (d) and 0.1 wt.-% for component (e).

Preferred are molding compositions according to the invention wherein component (a) forms a continuous phase in which component (b) is finely dispersed.

Preferred are molding compositions wherein the values of the refractive index (RI) at 589.3 nm of components (a) and (b) differ no more than 0.02, preferably no more than 0.01, more preferably no more than 0.005, often no more than 0.003. This results in a product of particular high clarity and low haze. In general, the difference in in refractive index ΔRI, is calculated from the refractive indices of the individual components according to the following formula:

ΔRI=|RI(a)−RI(b)|
with:
ΔRI=difference in refractive index RI,
RI(a)=refractive index of component(s) (a),
RI(b)=refractive index of component(s) (b).

If the molding composition comprises more than one component (a) and/or more than one component (b), the difference in refractive index ΔRI is calculated from the refractive indices of the individual components weighted according to the respective mass fractions of each component.

In one preferred embodiment, the molding composition according to the invention consists of the components (a), (b), (c), and optionally (d) and/or (e).

### Component (a)

Preferred are random copolymers (a)—as component (a)—made from 40 to 65 wt.-% vinylaromatic monomer (a11), in particular styrene, and from 35 to 60 wt.-% of methyl methacrylate (a12); more preferred are random copolymers (a) made from 45 to 63 wt.-%, more preferably 48 to 60 wt.-%, and often 50 to 58 wt.-%, of vinylaromatic monomer (a11) and from 37 to 55 wt.-%, more preferably 40 to 52 wt.-%, and often 42 to 50 wt.-%, of methyl methacrylate (a12). In said compositions the total amount of (a11) and (a12) is 100 wt.-%.

Styrene-methyl methacrylate (SMMA) copolymers (a) may be obtained in a known manner by bulk, solution, suspension, precipitation or emulsion polymerization. Details of these processes are described, for example, in Kunststoffhandbuch, ed. R. Vieweg and G. Daumiller, Vol. V “Polystyrol”, Carl-Hanser-Verlag Munich, 1969, p. 118 ff. SMMA copolymers (a) are known products which are commercially available e.g. from Ineos Styrolution (Frankfurt, Germany) as NAS® XC.

### Component (b)

The at least one, preferably one, vinylaromatic-diene block copolymer (b)—as component (b)—may be a linear or star-shaped block copolymer and comprises at least one hard block S made from vinylaromatic monomers, in particular styrene, and at least one soft block B made from dienes and/or at least one soft block B/S made from dienes and vinylaromatic monomers. In one embodiment of the invention, the at least one vinylaromatic-diene block copolymer (b)—as component (b)—may be a linear block copolymer comprising one hard block S made from vinylaromatic monomers, in particular styrene, and one soft block B made from dienes and/or at least one soft block B/S made from dienes and vinylaromatic monomers.

In an alternative embodiment, the at least one vinylaromatic-diene block copolymer (b)—as component (b)—may be a linear or star-shaped block copolymer comprising at least two hard blocks S made from vinylaromatic monomers, in particular styrene, and at least one soft block B made from dienes and/or at least one soft block B/S made from dienes and vinylaromatic monomers. In a preferred embodiment thereof, the at least two hard blocks S made from vinylaromatic monomers constitute preferably terminal blocks of the vinylaromatic-diene block copolymer (b).

Generally, based on the entire block copolymer, the proportion of the diene is from 47 to 67 wt.-%, and the proportion of the vinylaromatic monomer is from 33 to 53 wt.-%.

Preferably, based on the entire block copolymer, the proportion of the diene is from 50 to 65 wt.-%, more preferably 52 to 62 wt.-%, often 55 to 60 wt.-%, and the proportion of the vinylaromatic monomer is from 35 to 50 wt.-%, more preferably 38 to 48 wt.-%, often 40 to 45 wt.-%.

Vinyl aromatic monomers which may be used for the hard (polymer) blocks S or else for the soft (copolymer) block B/S are styrene, α-methylstyrene, p-methylstyrene, ethylstyrene, tert-butylstyrene, vinyl toluene or mixtures of these, preferably styrene. The hard (polymer) blocks S of the block copolymer (b) are hard phases with a glass transition temperature (Tg)>70° C.

The hard blocks S can be made from 95 to 100 wt.-% of at least one vinylaromatic monomer and 0 to 5 wt.-% of at least one diene, preferably the hard blocks S are homopolymers made from vinylaromatic monomers, in particular styrene.

Suitable dienes which may be used for the preparation of component (b) are conjugated dienes. Preferred dienes for the at least one soft block B or the at least one soft block B/S (or optionally for the hard blocks S) are 1,3-butadiene, isoprene, 2,3-dimethylbutadiene, 1,3-pentadiene, 1,3-hexadienes or piperylene or mixtures of these, particularly preferably 1,3-butadiene. The soft (polymer) block B and/or soft (copolymer) block B/S is a soft phase with a Tg<0° C.

The soft block B may be made from 95 to 100 wt.-% of at least one diene and 0 to 5 wt.-% of at least one vinylaromatic monomer, preferably the soft block B is a homopolymer made from a conjugated diene, in particular 1,3-butadiene.

Often the soft block is a block B/S, in particular a random block B/S. A “random” block B/S means a copolymer block having a statistical distribution of the polymerized units of the vinylaromatic monomers and dienes.

Often the (copolymer) block B/S, in particular the random copolymer block B/S, is made from more than 5 to 39 wt.-%, in particular 6 to 39 wt.-%, vinylaromatic monomer, in particular styrene, and from 61 to less than 95 wt.-%, in particular 61 to 94 wt.-%, diene, in particular 1,3-butadiene, wherein the total amount of the vinyl aromatic monomer and the diene is 100 wt.-%.

Preferably, block copolymer (b) is a linear block copolymer with one or more hard block(s) S, preferably terminal hard blocks S, and, at least one soft block B and/or at least one soft block B/S.

There may also be more than one, preferably random, (copolymer) block B/S. Often block copolymer (b) comprises at least 2, in particular random, soft (copolymer) blocks (B/S) 1 and (B/S) 2 having different proportions of vinylaromatic monomers and therefore different glass transition temperatures. For all copolymer blocks B/S such as (B/S) 1, (B/S) 2 etc., Tg is <0° C., generally in the range between −80° to 0° C., preferably in the range from −70° C. to −20° C., particularly preferably from −70 to −40° C.

According to the present invention, Tg is measured by methods known to the SBC-polymer chemist, e.g. differential scanning calorimetry (DSC).

According to one embodiment, block copolymer (b) is a block copolymer of the structure S-B, in particular a styrene-butadiene block copolymer of the structure S-B.

According to a further embodiment, block copolymer (b) is a block copolymer of the structure S-B-S, in particular a styrene-butadiene block copolymer of the structure S-B-S.

According to an embodiment block copolymer (b) is a block copolymer of the structure S-B/S-S, in particular a styrene-butadiene block copolymer of the structure S-B/S-S.

The block copolymers (b) are prepared preferably by sequential anionic polymerization. The aforementioned SBC products are known. Their preparation is described for example in “Modern Styrenic Polymers: Polystyrenes and Styrenic Copolymers” (Eds., J. Scheirs, D. Priddy, Wiley, Chichester, UK, (2003), pages 502 to 507) and in particular in U.S. Pat. No. 6,521,712 (col. 2, I. 52 to col. 4, line 2).

Examples of block copolymers (b) are known product and commercially available as Calprene® 743X from Dynasol, USA.

### Component (c)

The thermoplastic molding composition further comprises 0.01 to 1.0 wt.-%, preferably 0.02 to 0.8 wt.-%, of at least one light stabilizer (c) (as component (c)).

In general, all known light stabilizers, i.e. stabilizers to counter the effect of light on SMMA and SBC molding compositions, known in the art are suitable. Examples of suitable stabilizers to counter the effect of light (e.g. UV-stabilizers) are various substituted resorcinols, salicylates, benzotriazoles, benzophenones, and HALS (hindered amine light stabilizers), for example those commercially available as Tinuvin®, and mixtures of the mentioned light stabilizers. Particularly preferred embodiments of light stabilizers include benzotriazole stabilizers and HALS stabilizers and mixtures thereof. Often a mixture of at least one benzotriazole stabilizer and at least one HALS stabilizer is used. Suitable benzotriaziole stabilizers include e.g. 2-[2-hydroxy-5-(1,1,3,3-tetramethylbutyl)-phenyl]-2H-benzotriazol (CAS-No.: 3147-75-9), commercially available as Tinuvin® 329 from BASF SE, Germany. Suitable HALS stabilizers include bis-(2,2,6,6-tetramethyl-4-piperidyl)-sebacate (CAS-No.: 52829-07-9), commercially available as Tinuvin® 770 from BASF SE, Germany. The light stabilizers (c) are generally used in total amounts of up to 1 wt.-%, based on the molding composition. In one embodiment, the light stabilizers (c) comprises or is composed of a mixture of at least one benzotriazole stabilizer and at least one HALS stabilizer in a weight ratio of 1:1 to 3:1, preferably 1.5:1 to 2.5:1, often in a weight ratio of 2:1.

These light stabilizer (c) may be admixed at any stage of the manufacturing operation, but preferably at an early stage in order to profit early on from the stabilizing effects (or other specific effects) of the added substance.

### Component (d)

Optionally, the thermoplastic molding composition may further comprise up to 1.0 wt.-%, preferably 0.1 to 1.0 wt.-%, often 0.3 to 0.9 wt.-%, of at least one antioxidant (d) (as component (d)). The term antioxidant includes antioxidants as well as oxidation retarders and heat stabilizers and mixtures thereof.

Suitable antioxidants are, e.g., one or more compounds selected from monophosphite-based antioxidants, diphosphite-based antioxidants and sterically hindered phenolic antioxidants. If one or more antioxidants are present, they are preferably selected from monophosphite-based antioxidants, such as trisubstituted monophosphite derivatives, diphosphite-based antioxidants, such as substituted pentaerythrirol diphosphite derivatives and sterically hindered phenolic antioxidants, such as 2,6-di-tertbutylphenolic derivatives. Examples of suitable antioxidants include octadecyl-[3-(3,5-di-tert-butyl-4-hydroxyphenyl) propionate] (CAS-No.: 2082-79-3), available as Irganox® 1076 from BASF SE, Germany, and bis-(2,4-di-tert.-butylphenol) pentaerythritol diphosphite (CAS-No.: 26741-53-7), available as Irgafos® 126 from BASF SE, Germany.

Examples of oxidation retarders and heat stabilizers include halides of the metals from group I of the periodic table, examples being sodium, potassium and/or lithium halides, optionally in combination with copper (I) halides, e.g., chlorides, bromides, iodides, sterically hindered phenols, hydroquinones, different substituted representatives of these groups, and mixtures thereof.

The antioxidant (d) is typically present in concentrations of up to 1 wt.-%, based on the weight of the molding composition.

These antioxidants (d) may be admixed at any stage of the manufacturing operation, but preferably at an early stage in order to profit early on from the stabilizing effects (or other specific effects) of the added substance.

### Component (e)

Optionally, the thermoplastic molding composition may comprise up to 5.0 wt.-%, preferably 0.10 to 3.0 wt.-%, of at least one further additive and/or processing aids (e) (as component (e)) which is different from the light stabilizer (c) and the antioxidant (d).

Suitable additives and/or processing aids (e) include all substances customarily employed for processing or finishing the polymers, except of fillers/fibers and pigments (see e.g. “Plastics Additives Handbook”, Hans Zweifel, 6th edition, Hanser Publ., Munich, 2009).

Preferred additives and/or processing aids (e) are such as lubricants, glidants, demolding agents and dyes.

Suitable lubricants/glidants and demolding agents include stearic acids, stearyl alcohol, stearic esters, amide waxes (bisstearylamide, in particular ethylenebisstearamide), polyolefin waxes and/or generally higher fatty acids, derivatives thereof and corresponding fatty acid mixtures comprising 12 to 30 carbon atoms.

Suitable dyes are any of the dyes which can be used for the transparent, semitransparent, or non-transparent coloring of polymers, in particular those dyes which are suitable for coloring styrene copolymers. Dyes of this type are known to the skilled worker.

These additives and/or processing aids (e) may be admixed at any stage of the manufacturing operation, but preferably at an early stage in order to profit early on from the stabilizing effects (or other specific effects) of the added substance.

### Process for the Preparation

A further aspect of the invention is a process for the preparation of a molding composition according to the invention by melt-mixing of components (a), (b), (c) and, if appropriate, component(s) (d) and/or (e). Preferably the melt-mixing of the components (a), (b), (c) and, if appropriate, (d) and/or (e) is performed in an extruder, preferably a twin screw extruder.

The melt-mixing may be performed, preferably in an extruder, at temperatures in the range of from 160 to 260° C.

Preferably, melt-mixing is performed in an extruder at temperatures in the range of from 180 to 230° C.

The molding composition obtained by said process shows a good processability and thus can be easily processed, i.e. molded to any desired shape e.g. by extrusion and hot molding (e.g. injection molding).

Accordingly, a further aspect of the invention is a shaped article produced from the molding composition according to the invention.

The molding composition according to the invention and shaped articles produced therefrom show a good balance of stiffness and toughness, with a high light stability and processability while maintaining a high transmittance and clarity.

Preferably, the molding composition has a specific gravity of less than 1.15, typically less than 1.12, determined according to ASTM D792.

The molding composition according to the invention has good light stability and low initial haze. In particular, the molding composition according to the invention is characterized by having preferably less than 3.5 units of yellowness index increase (ΔYI) after UV stability testing for 600 hours, more preferably less than 3.2 units of yellowness index increase (ΔYI), wherein the UV stability testing is conducted according to AATCC TM16.3, and wherein yellowness index is calculated according to ASTM E313 from measured CIELAB color space values, which are measured using a D65 light source (observation angle) 10° according to ASTM E1348.

Moreover, the molding composition according to the invention is characterized by having preferably less than 2.2 units of color change (ΔE) after UV stability testing for 600 hours, more preferably less than 2.0 units of color change (ΔE), wherein the UV stability testing is conducted according to AATCC TM16.3, and wherein color change (ΔE) is calculated according to ASTM D2244 from measured CIELAB color space values, which are measured using a D65 light source (observation angle) 10° according to ASTM E1348.

Furthermore, the molding composition according to the invention is characterized by having preferably less than 5% initial haze determined according to ASTM D1003, more preferably less than 4%, typically less than 3.5%.

The molding composition according to the invention also exhibits improved processability in particularly with respect to its melt flow rate. The molding composition according to the invention preferably has a melt flow rate (MFR) determined according to ASTM D1238 at 220° C. and 10 kg of at least 25 g/10 min, more preferably at least 30 g/10 min.

The molding compositions according to the invention can advantageously be used for many applications, e.g. housewares, home appliances, such as lighting and light covers, blends as well as cap layers and protective covers.

A further subject of the invention is the use of molding compositions according to the invention and shaped articles produced therefrom for various applications for housewares, home appliances, such as lighting and light covers, blends as well as cap layers and protective covers, cap layers for sanitary applications, point of purchase displays, container holders, display holders, and lighting.

The examples, figures and patent claims further illustrate the invention.

### EXAMPLES

### Test Methods:

Specific gravity was determined according to ASTM D792.
Refractive index at 589.3 nm and 23° C. was determined analogously to ASTM C 1648-12 using a Metricon® Model 2010/M Prism Coupler (particular reference is made to section 9.4 of ASTM C 1648-12).
Melt flow rate (MFR) was determined according to ASTM D1238 at 220° C. and 10 kg.
Tensile stress at yield and tensile strain at break were determined in the test according to norm ASTM D638-14.
Un-notched Izod impact strength was determined in accordance with ASTM D4812.
Haze and optical properties (transmission, clarity) were determined in accordance with ASTM D1003 for ⅛″ thickness specimen.
UV stability testing was conducted according to AATCC TM16.3 with xenon irradiance (420 nm) of 1.10 W/m2 over black panel at 63° C.
Yellowness Index was calculated according to ASTM E313 from measured CIELAB color space values. CIE color space values measured using a D65 light source (observation angle) 10° according to ASTM E1348.
Color Change (ΔE) was calculated according to ASTM D2244 from measured CIELAB color space values. CIE color space values measured using a D65 light source (observation angle) 10° according to ASTM E1348.

Starting materials used in the examples:
SMMA (a) random styrene/methyl methacrylate-copolymer, MMA content: 45 wt.-%, comprising 0.13 wt.-% of antioxidants (d); refractive index at 589.3 nm of 1.549.
SBS (b) linear styrene butadiene SBS block copolymer; total styrene content 43 wt.-%, comprising 0.45 wt.-% of antioxidants (d); refractive index at 589.3 nm of 1.551.
light stabilizer (c-1) Hindered amine light stabilizer Tinuvin® 770, CAS-No.: 52829-07-9, BASF SE
light stabilizer (c-2) UV absorber Tinuvin® 329, CAS-No.: 3147-75-9, BASF SE.

Reference Example 1 (Ref. 1) is a commercial available (methyl methacrylate butadiene styrene (MBS) polymer composition, available as Zylar® 631, INEOS Styrolution.

Reference Example 2 (Ref. 2) is a commercial available PMMA polymer composition Plexiglas® DR101, obtained from Arkema, France.

Reference Example 3 (Ref. 3) is a mixture of two commercially available PMMA polymer compositions (Plexiglas® V825 and Plexiglas® DR101 (both obtained from Arkema, France) in a weight ratio of 80:20).

The materials as shown in Table 1 were melt-mixed using a 30 mm twin screw extruder with zone temperatures set from 180 to 230° C. From the obtained molding compositions specimens were injection molded and the parts tested for their mechanical and optical properties. Tables 1 and 3 show the properties of the injection molded specimens for examples 1 and 2 as well as comparative examples C1, C2 and C3. Tables 1 to 3 further evidence the benefit of samples according to the invention (Examples 1 and 2) as compared to current commercial styrenic impact modified clear molding compositions such as Zylar® 631 (impact modified styrene acrylic copolymer (methyl methacrylate butadiene styrene (MBS) resin), Plexiglas® DR101 (impact modified methyl methacrylate resin (PMMA)) and blends of Plexiglas® V825 (methyl methacrylate resin (PMMA)) and Plexiglas® DR101 used in Reference Examples 1 to 3 (Ref. 1 to Ref. 3).

TABLE 1
Formulations and mechanical and optical properties of Examples
1 and 2, and Comparative Examples C1, C2 and C3.

| | Examples | | Comparative Examples | | |
|---|---|---|---|---|---|
| Units | 1 | 2 | C1 | C2 | C3 |

Composition

| | | | | | | |
|---|---|---|---|---|---|---|
| SMMA (a) | % | 95.9 | 80.7 | 100 | 96.2 | 81 |
| SBS (b) | % | 3.8 | 19 | 0 | 3.8 | 19 |
| light stabilizer (c-1) | % | 0.2 | 0.2 | 0 | 0 | 0 |
| light stabilizer (c-2) | % | 0.1 | 0.1 | 0 | 0 | 0 |

Mechanical Properties

| | | | | | | |
|---|---|---|---|---|---|---|
| MFR (220° C., 10 kg) | g/10 min | 32 | 65 | 25 | 31 | 65 |
| Specific Gravity | unitless | 1.10 | 1.07 | 1.11 | 1.10 | 1.07 |
| Tensile Stress at Yield | MPa | 62.1 | 38.1 | 59.8 | 61.4 | 38.9 |
| | (psi) | (9000) | (5520) | (8670) | (8900) | (5640) |
| Tensile Strain at | % | 4 | 22 | 3 | 4 | 21 |
| Break | | | | | | |
| Unnotched Izod | J/m | 270 | 875 | 175 | 230 | 780 |
| | (Ft-lb/in) | (5) | (16) | (3) | (5) | (15) |

Optical Properties

| | | | | | | |
|---|---|---|---|---|---|---|
| Haze | % | 2.0 | 3.0 | 0.7 | 1.1 | 3.4 |
| Transmittance | % | 91.7 | 91.4 | 92.7 | 92.5 | 91.6 |
| Clarity | % | 99.0 | 99.2 | 99.6 | 99.1 | 98.7 |

As shown by Table 1, the molding compositions according to the invention (Examples 1 and 2) exhibit a good balance of stiffness and toughness, with higher melt flow rate compared to Comparative Example C1. The specific gravity is slightly reduced. Optical appearance is comparable to comparative examples C2 and C3 comprising no light stabilizer.

TABLE 2
Mechanical/optical properties of Reference
Example Ref. 1, Ref. 2 and Ref. 3.

| | Reference Examples | | |
|---|---|---|---|
| Units | Ref. 1 | Ref. 2 | Ref. 3 |

Mechanical Properties

| MFR (220° C., | g/10 min | 40 | | 3 | | 11 |
|---|---|---|---|---|---|---|
| 10 kg) | | | | | | |
| Specific Gravity | unitless | 1.05 | | 1.16 | | 1.18 |
| Tensile Stress | MPa | 29.4 | (4270) | 36.6 | (5310) | n/a |
| at Yield | (psi) | | | | | |
| Tensile Strain | % | 34 | | 32 | | n/a |
| at Break | | | | | | |
| Un-notched | J/m | 1730 | (32) | 680 | (13) | n/a |
| Izod | (Ft-lb/in) | | | | | |

Optical Properties

| | | | | |
|---|---|---|---|---|
| Haze | % | 1.6 | 1.8 | 2.1 |
| Transmittance | % | 91.5 | 92.7 | 93.1 |
| Clarity | % | 99.4 | 99.5 | 99.0 |

n/a means data not available.

Table 2 shows the experimental data for commercially used polymer compositions (Reference Examples Ref. 1 to Ref. 3). Ref. 2 and Ref. 3 exhibit a high gravity and low melt flow rate which is disadvantageous for the processing of the polymer composition since more energy is required for the processing and a higher amount of polymer composition is required to produce a molded article of a certain volume. Ref. 1 exhibits a lower specific gravity and a higher melt flow rate compared to Ref. 2 and Ref. 3, but is inferior with respect to its light stability compared to the inventive Examples 1 and 2 (cf. Table 3).

TABLE 3
Light stability during UV exposure

| | | | | | | Reference | | |
|---|---|---|---|---|---|---|---|---|
| | | | Comparative | | | Examples | | |
| | Examples | | Examples | | | Ref. | Ref. | Ref. |
| Units | 1 | 2 | C1 | C2 | C3 | 1 | 2 | 3 |

After 0 hours of UV exposure

| | | | | | | | | | |
|---|---|---|---|---|---|---|---|---|---|
| YI | unitless | 0.7 | 1.4 | 0.5 | 0.5 | 1.2 | 1.2 | 0.4 | 0.4 |
| L* | unitless | 95.9 | 95.9 | 96.3 | 96.2 | 95.9 | 95.7 | 96.4 | 96.6 |
| a* | unitless | 0.1 | 0.0 | 0.1 | 0.1 | 0.1 | 0.0 | 0.0 | 0.0 |
| b* | unitless | 0.4 | 0.8 | 0.2 | 0.2 | 0.6 | 0.6 | 0.2 | 0.2 |

After 300 hours of UV exposure

| | | | | | | | | | |
|---|---|---|---|---|---|---|---|---|---|
| YI | unitless | 1.1 | 1.4 | 0.9 | 1.9 | 3.5 | 5.0 | 0.1 | 0.4 |
| ΔYI | unitless | 0.4 | −0.1 | 0.4 | 1.4 | 2.3 | 3.8 | −0.4 | −0.1 |
| L* | unitless | 95.9 | 95.9 | 96.3 | 96.1 | 95.9 | 95.6 | 96.4 | 96.5 |
| a* | unitless | 0.0 | 0.0 | 0.0 | −0.2 | −0.4 | −0.7 | 0.1 | 0.1 |
| b* | unitless | 0.6 | 0.7 | 0.5 | 1.1 | 2.0 | 2.9 | 0.0 | 0.2 |
| ΔE | unitless | 0.2 | 0.1 | 0.3 | 0.9 | 1.5 | 2.4 | 0.2 | 0.0 |

After 600 hours of UV exposure

| | | | | | | | | | |
|---|---|---|---|---|---|---|---|---|---|
| YI | unitless | 1.2 | 1.5 | 1.2 | 3.5 | 4.9 | 7.7 | 0.1 | 0.4 |
| ΔYI | unitless | 0.5 | 0.1 | 0.8 | 3.1 | 3.8 | 6.5 | −0.3 | −0.1 |
| L* | unitless | 95.8 | 95.9 | 96.2 | 96.0 | 95.7 | 95.4 | 96.4 | 96.6 |
| a* | unitless | 0.0 | −0.1 | −0.1 | −0.4 | −0.6 | −1.1 | 0.0 | 0.1 |
| b* | unitless | 0.7 | 0.8 | 0.7 | 2.0 | 2.8 | 4.5 | 0.1 | 0.2 |
| ΔE | unitless | 0.3 | 0.1 | 0.5 | 1.9 | 2.4 | 4.0 | 0.2 | 0.0 |

Table 3 summarizes the light stability test results upon UV exposure according AATCC TM16.3 with xenon irradiance (420 nm) of 1.10 W/m2 over black panel at 63° C. after 0 hours, 300 hours and 600 hours for Examples 1 and 2, Comparative Examples C1 to C3 and Reference Examples Ref. 1 to Ref. 3.

The data show that Comparative Examples C2 and C3, as well as Reference Example Ref. 1 are clearly inferior with respect to light stability compared to inventive Example 1 and 2. Comparative Example 1 and Reference Examples Ref. 2 and Ref. 3 exhibit light stability comparable to inventive Examples 1 and 2, but have inferior properties with respect to specific gravity and melt flow rate (cf. Tables 1 and 2). Only the inventive Examples 1 and 2 combine light stability with a low specific gravity and a high melt flow rate.

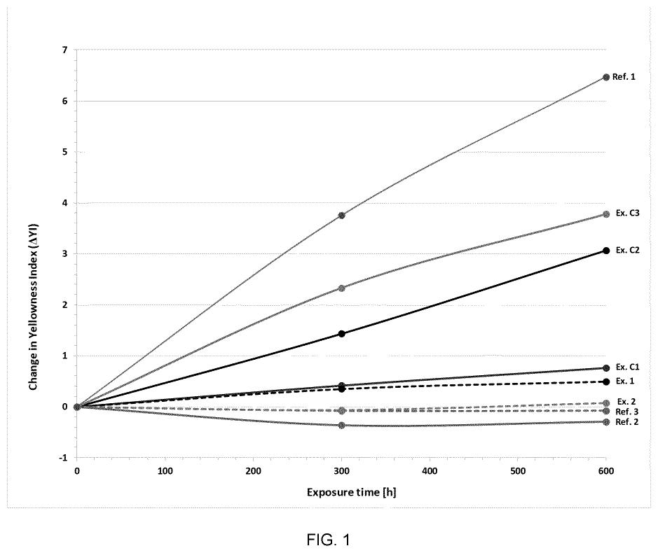

FIG. 1 depicts the plot of data obtained for the change in Yellowness Index (ΔYI) during UV exposure time (hours) according to AATCC TM16.3 for the examples, comparative examples and reference examples according to Table 3.

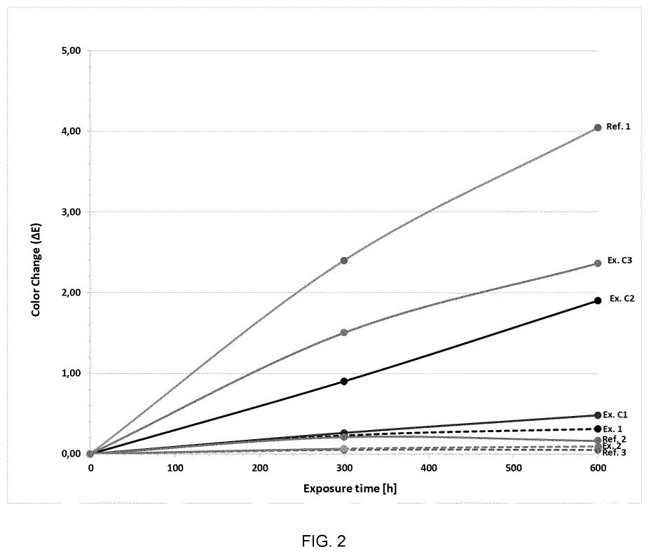

FIG. 2 depicts the plot of data obtained for the change in color (ΔE) during UV exposure time (hours) according to AATCC TM16.3 for the examples, comparative examples and reference examples according to Table 3.

The composition comprising a SMMA copolymer and a SBC-block copolymer as described by the invention showed high clarity and ductile properties.

1-15. (canceled)

16. A molding composition comprising components (a), (b), (c), (d) and (e), wherein
(a) 71 to 98.99 wt.-% of at least one random copolymer (a) made from 44 to 64 wt.-% of at least one vinylaromatic monomer (a11) and 36 to 56 wt.-% of methyl methacrylate (a12);
(b) 1 to 28.99 wt.-% of at least one vinylaromatic-diene block copolymer (b) comprising at least one hard blocks S made from vinylaromatic monomers and at least one soft block B made from dienes and/or at least one soft block B/S made from dienes and vinylaromatic monomers;
wherein the proportion of the diene based on the entire block copolymer (b) is from 47 to 67 wt.-%;
(c) 0.01 to 1.0 wt.-% of at least one light stabilizer (c);
(d) 0 to 1.0 wt.-% of at least one antioxidant (d); and
(e) 0 to 5 wt.-% of one or more additive(s) and/or processing aid(s) (e), wherein the one or more additive(s) and/or processing aid(s) (e) are different from the light stabilizer(s) (c) and antioxidant(s) (d);
wherein the total amount of components (a), (b), (c), (d) and (e) is 100 wt.-%.

17. The molding composition according to claim 16 comprising:
75 to 98.48 wt.-% of component (a),
1.5 to 24.98 wt.-% of component (b),
0.02 to 0.8 wt.-% of component (c),
0 to 1 wt.-% of component (d), and
0 to 5 wt.-% of component (e);
wherein the total amount of components (a), (b), (c), (d) and (e) is 100 wt.-%.

18. The molding composition according to claim 16 comprising:
90 to 97.95 wt.-% of component (a),
2 to 9.95 wt.-% of component (b),
0.05 to 0.4 wt.-% of component (c),
0 to 1 wt.-% of component (d), and
0 to 3 wt.-% of component (e);
wherein the total amount of components (a), (b), (c), (d) and (e) is 100 wt.-%.

19. The molding composition according to claim 16 comprising:
73 to 89.95 wt.-% of component (a),
10 to 26.95 wt.-% of component (b),
0.05 to 0.4 wt.-% of component (c),
0 to 1 wt.-% of component (d), and
0 to 3 wt.-% of component (e);
wherein the total amount of components (a), (b), (c), (d) and (e) is 100 wt.-%.

20. The molding composition according to claim 16, wherein the values of the refractive index at 589.3 nm of components (a) and (b) differ no more than 0.02.

21. The molding composition according to claim 16, wherein the random copolymer (a) is made from 40 to 65 wt.-% of vinylaromatic monomer (a11) and 35 to 60 wt.-% of methyl methacrylate (a12).

22. The molding composition according to claim 16, wherein the proportion of the diene in the vinylaromatic-diene block copolymer (b) is from 50 to 65 wt.-%.

23. The molding composition according to claim 16, wherein component (b) is a linear block copolymer with two terminal hard blocks S and at least one soft block B and/or at least one soft block B/S.

24. The molding composition according to claim 16, wherein component (b) is a styrene-butadiene block copolymer of the structure S-B-S or S-B/S-S.

25. The molding composition according to claim 16, wherein component (a) forms a continuous phase in which component (b) is finely dispersed.

26. The molding composition according to claim 16, wherein the molding composition has a specific gravity of less than 1.15 determined according to ASTM D792.

27. The molding composition according to claim 16, wherein the molding composition is characterized by having
(i) less than 2.0 units of yellowness index increase (ΔYI) after UV stability testing for 600 hours;
(ii) less than 2.0 units of color change (ΔE) after UV stability testing for 600 hours; and
(iii) less than 5% initial haze determined according to ASTM D1003;
wherein the UV stability testing is conducted according to AATCC TM16.3,
wherein yellowness index is calculated according to ASTM E313 from measured CIELAB color space values, which are measured using a D65 light source with an observation angle of 10° according to ASTM E1348, and
wherein color change (ΔE) is calculated according to ASTM D2244 from measured CIELAB color space values, which are measured using a D65 light source with an observation angle of 10° according to ASTM E1348.

28. A process for the preparation of the molding composition according to claim 16 comprising melt-mixing components (a), (b) and (c) and, if appropriate, component(s) (d) and/or (e).

29. A shaped article produced from the molding composition according to claim 16.

30. A houseware or home appliance comprising the molding composition according to claim 16.

31. The shaped article according to claim 29, wherein the shaped article is a houseware or home appliance.

32. The molding composition according to claim 17, wherein the values of the refractive index at 589.3 nm of components (a) and (b) differ no more than 0.02.

33. The molding composition according to claim 18, wherein the values of the refractive index at 589.3 nm of components (a) and (b) differ no more than 0.02.

34. The molding composition according to claim 19, wherein the values of the refractive index at 589.3 nm of components (a) and (b) differ no more than 0.02.
